(19) United States
(12) Patent Application Publication
(10) Pub. No.: US 2010/0141599 A1
(43) Pub. Date: Jun. 10, 2010

(54) TOUCH PANEL AND CIRCUIT THEREOF

(76) Inventors: Wen-Chun Wang, Taichung City (TW); Chien-Ting Chan, Chang Hua County (TW)

Correspondence Address: Muncy, Geissler, Olds & Lowe, PLLC, 4000 Legato Road, Suite 310, FAIRFAX, VA, 22033, US

(21) Appl. No.: 12/632,486

(22) Filed: Dec. 7, 2009

(30) Foreign Application Priority Data
Dec. 8, 2008 (TW) 097147581

(51) Int. Cl. G06F 3/041

(52) U.S. Cl. 345/173

(57) ABSTRACT

A sensing circuit for touch panel is disclosed. The sensing circuit includes a switching device, a passive device, a sensing device and a transforming unit. The switching device receives a first control signal and outputs the first control signal according to a second control signal. The passive device couples to the switching device. The sensing device couples to the switching device to form a node, receives the first control signal to generate a reference voltage on the node, and changes the value of the reference voltage to generate a target voltage according to a pressure exerting on a preset position of the surface of the touch panel by a user. The transforming unit receives the target voltage and generates an output current according to the target voltage.

This application claims the benefit of Taiwan Application Ser. No. “097147581”, filed on “Dec. 8, 2008”, the content of which is incorporated herein by reference.

### BACKGROUND OF THE INVENTION

1. Field of the invention

The invention relates to a display device with a built-in touch panel, particularly to a touch panel and the sensing circuit thereof.

2. Description of the Related Art

A general touch display device with a built-in touch panel has complicated circuits distributed throughout the panel, such as Vcom circuit, data circuit, scan circuit, and so forth. In order to sense the position on the panel that is touched by a user's finger, a general touch panel usually recognizes the touched position by way of fetching the sensing voltage. However, the horizontal or vertical portions of the circuits in the panel are affected by environmental interferences due to these circuits distributed in the panel, such as stray capacitor(s) and so on. Thus, a general sensing circuit for a touch panel is unable to steadily output signals to external circuit(s) and thus it results in error operation to thereby affect the sensing accuracy.

### SUMMARY OF THE INVENTION

In view of the above mentioned problems, one object of the invention is to provide a signal transforming circuit for achieving the effect of transforming voltage sensing into current sensing.

One object of the invention is to provide a touch panel and the sensing circuit thereof. The variation of the voltage level in the sensing circuit that is caused by the environmental interferences can be reduced through the process of transforming voltage into current.

One object of the invention is to provide a touch panel and the sensing circuit thereof. The sensing accuracy can be increased through the process of transforming voltage into current.

One embodiment of the invention is to provide a signal transforming circuit applicable to a sensing circuit for a touch panel. The signal transforming circuit comprises at least a transforming unit. One terminal of the transforming unit couples to a voltage source or a Vcom signal. The transforming unit receives at least a target voltage and then adjusts the output current passing through the transforming unit according to the target voltage. The target voltage varies with at least three variables provided by the sensing circuit. The three variables comprise a first variable, a second variable, and a third variable wherein the first variable is the variances of the capacitance generated by the sensing circuit while being touched by a user, the second variable is an enable state of a first signal which is input to the sensing circuit, and the third variable is an enable state of a second signal which is input to the sensing circuit.

Furthermore, another embodiment of the invention provides a sensing circuit corresponding to a pixel or a plurality of pixels of the panel where each and every pixel corresponds to a preset position on the surface of the panel. The sensing circuit for a touch panel comprises a sensing control unit and a transforming unit. The sensing control unit generates at least a sensing signal according to the pressure exerting on a preset position of the touch panel by a user and determines a target voltage according to the sensing signal. The transforming unit receives the target voltage and then adjusts the output current passing through the transforming unit according to the target voltage.

In addition, another embodiment of the invention provides a sensing circuit corresponding to a pixel or a plurality of pixels of the panel where each and every pixel corresponds to a preset position on the surface of the panel. The sensing circuit comprises a switching device, a passive device, a sensing device and a transforming unit. The switching device receives a first control signal and outputs the first control signal according to a second control signal. The passive device couples to the switching device. The sensing device couples to the switching device to form a node and receives the first control signal. A reference voltage is generated on the node and the value of the reference voltage is adjusted according to the pressure exerting on a preset position of the touch panel by a user so as to generate a target voltage. The transforming unit receives the target voltage and adjusts the output current passing through the transforming unit according to the target voltage.

Moreover, another embodiment of the invention provides a touch panel. The touch panel comprises a plurality of pixels. Each and every pixel corresponds to a preset position on the surface of the panel and one pixel or a plurality of pixels corresponds to a sensing circuit. The sensing circuit comprises a switching device, a first capacitor, a sensing device and a transforming unit. The on/off state of the switching device is controlled by at least a signal. The first capacitor couples to two terminals of the switching device. The sensing device couples to one terminal of the switching device to form a node. A reference voltage is generated on the node when the switching device is on. The sensing device adjusts the reference voltage to generate a target voltage according to whether the preset position is touched or not, or the extent of touching the preset position. The transforming unit receives the target voltage and outputs a corresponding output current according to the target voltage.

The touch panel and the sensing circuit thereof according to embodiments of the invention utilize the transforming unit by transforming voltage into current to reduce the variation of the voltage level in the sensing circuit caused by the environmental interferences. For example, the parasitic effect of interior circuit layout in the panel. Then, sensing accuracy is increased greatly and the problems in the prior art can be solved.

Further scope of the applicability of the present invention will become apparent from the detailed description given hereinafter. However, it should be understood that the detailed description and specific examples, while indicating preferred embodiments of the invention, are given for illustration only, since various changes and modifications within the spirit and scope of the invention will become apparent to those who are skilled in the art from the following detailed description.

### BRIEF DESCRIPTION OF THE DRAWINGS

FIG. 1 shows a schematic diagram illustrating a display device with a built-in touch panel.

FIG. 2 shows a schematic diagram illustrating the sensing circuit for a touch panel according to one embodiment of the invention.

FIG. 3A shows a schematic diagram illustrating the sensing circuit for a touch panel according to another embodiment of the invention.

FIG. 3B shows a schematic diagram illustrating the pressure-sensing type switching device in FIG. 3A.

FIG. 4 shows a schematic diagram illustrating the sensing circuit for a touch panel according to another embodiment of the invention.

FIG. 5 shows a schematic diagram illustrating the sensing circuit for a touch panel according to another embodiment of the invention.

FIG. 6 shows a schematic diagram illustrating the sensing circuit for a touch panel according to another embodiment of the invention.

FIG. 7 shows a schematic diagram illustrating the sensing circuit for a touch panel according to another embodiment of the invention.

FIG. 8 shows a schematic diagram illustrating the sensing circuit for a touch panel according to another embodiment of the invention.

FIG. 9 shows a schematic diagram illustrating the sensing circuit for a touch panel according to another embodiment of the invention.

FIG. 10 shows a schematic diagram illustrating the sensing circuit for a touch panel according to another embodiment of the invention.

### DETAILED DESCRIPTION OF THE INVENTION

The present invention will become more fully understood from the detailed description given herein below and the accompanying drawings which are given for illustration only and thus are not to limit the scope of the present invention.

The signal transforming circuit, the touch panel and the sensing circuit thereof according to the invention are described in details with reference to the accompanying drawings.

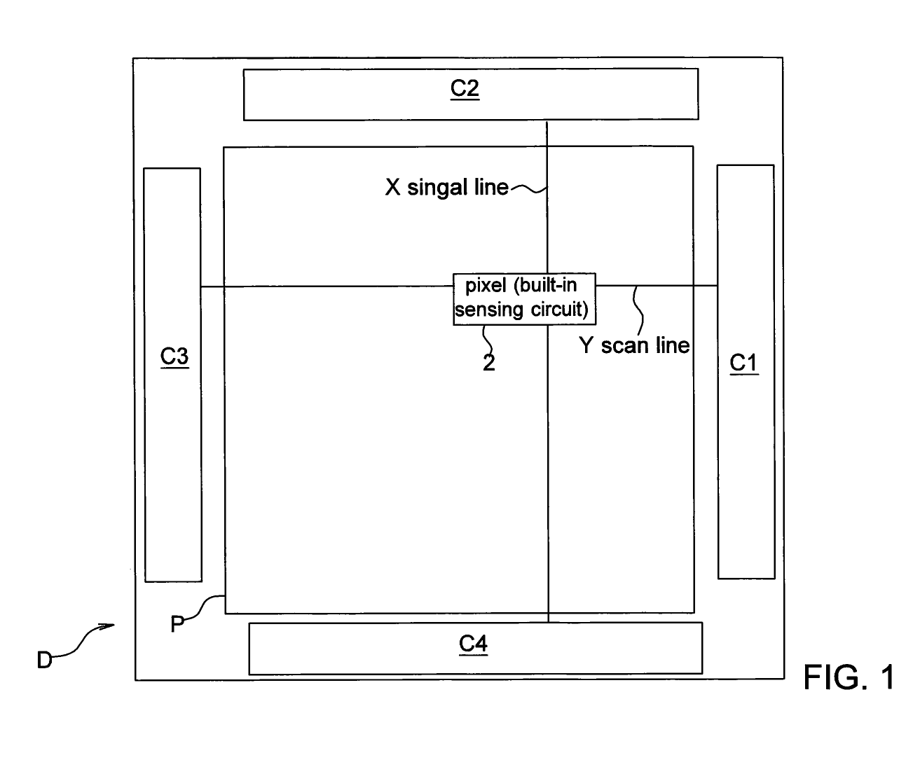

FIG. 1 shows a schematic diagram illustrating a display device D. As shown in FIG. 1, the display device D includes at least a pixel region P and a plurality of circuit blocks C1˜C4 disposed on the sides of the pixel region P. In the pixel region P, a plurality of scan lines Y and a plurality of signal lines X are disposed. The scan line Y and the signal line X intersect to each other and a pixel 2 is disposed on each intersecting position. It should be noted that the number of circuit blocks C1˜C4 is not limited to the above example and can be adjusted depending on design. For clarity, only one pixel is drawn to illustrate the relation among the pixel 2, the scan line Y and the signal line X. In fact, the number of pixel 2 corresponds to the resolution of the panel. One pixel 2 or a plurality of pixels 2 correspond to the sensing circuit according to the embodiment of the invention. Certainly, the number of the pixels (resolution of the panel) corresponding to the sensing circuit is adjusted freely by designers. The operation of the pixel region P and the circuit blocks C1˜C4 should be well known to those who are skilled in the art and thus will not be described in detail.

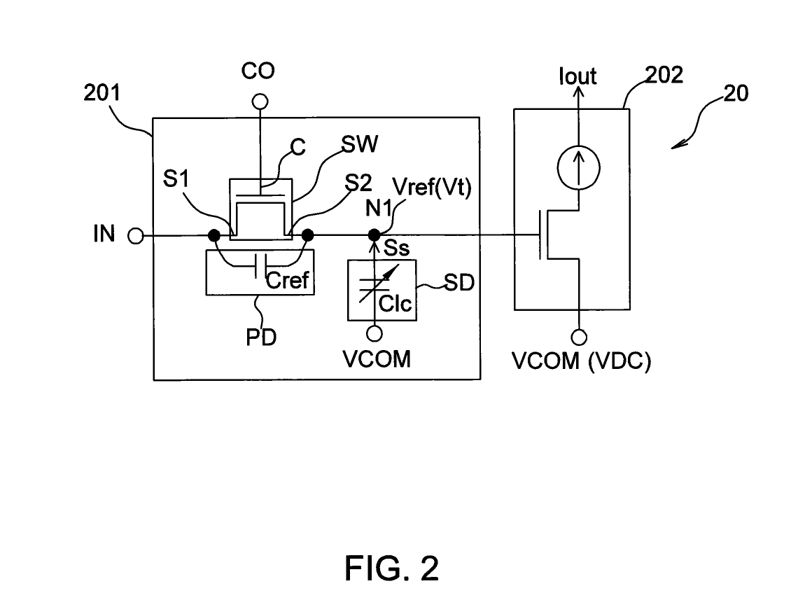

FIG. 2 shows a schematic diagram of the sensing circuit for a touch panel according to one embodiment of the invention. The sensing circuit 20 is applicable to the display device D with a built-in touch panel and is disposed corresponding to a pixel 2 or a plurality of pixels 2 of the above pixel block P. Each and every pixel 2 corresponds to a preset position on the surface of the panel. In addition, when a user touches or presses the panel, at least a physical quantity is generated on the pixel 2 and then a corresponding electrical signal is generated according to the physical quantity sensed by the sensing circuit 20.

The sensing circuit 20 comprises a sensing control unit 201 and a transforming unit 202. The sensing control unit 201 receives at least a control signal (shown as IN or CO in the drawing). The control signal drives the sensing control unit 201. The sensing control unit 201 generates at least a sensing signal Ss according to the pressure exerting on the preset position of the panel touched by a user and determines the value of the target voltage Vt on the node N1 according to the control signal and the sensing signal. The transforming unit 202 receives a target voltage Vt and adjusts the output current Iout passing through the transforming unit 202 according to the value of the target voltage.

In one embodiment, the sensing control unit 201 comprises a switching device SW, a passive device PD, and a sensing device SD.

The switching device SW receives a first control signal IN and determines how to output the first control signal IN according to a second control signal CO. In one embodiment, the switching unit SW may be a thin film transistor (TFT) which comprises at least one control terminal C, at least one input terminal S1 and at least one output terminal S2. The input terminal S1 of the switching device SW receives a first control signal IN. The control terminal C determines the state (either ON or OFF) of the switching device SW according to a second control signal CO and thus determines how to output the first control signal IN. Certainly, in another embodiment, the switching device SW can be any other current semiconductor device or any semiconductor device to be developed in the future.

The passive device PD couples to the switching device SW. In one embodiment, the passive device PD may be a capacitor, one terminal of which couples to the output terminal S2 of the switching device SW and the other terminal of which couples to the input terminal S1. In another embodiment, the passive PD may be any other current passive device or any passive device to be developed in the future.

The sensing device SD senses the physical quantity generated on any position of the surface of the panel that is touched or pressed by a user, and transforms the physical quantity into an electrical signal. In one embodiment, the sensing device SD may be a variable capacitor. In another embodiment, the sensing device SD may be a current sensing device having physical sensing function or any sensing device with physical sensing function to be developed in the future. In one embodiment, one terminal of the sensing device SD couples to the output terminal S2 of the switching device SW to form a node N1 and the other terminal couples to the common point VCOM. During operation, the sensing device SD receives the first control signal IN and generates a reference voltage Vref on the node N1. When the user touches a position on the surface of the panel and this position corresponds to a pixel position of the pixel block P in the FIG. 2, the sensing device SD of the sensing circuit 20 of the pixel position adjusts the value of the reference voltage Vref according to the extent (touching pressure) of touching the pixel position by a user so as to generate a target voltage Vt. For example, in one embodiment, as the sensing device SD is a variable capacitor, the sensing device SD changes the cell gap of the variable capacitor according to whether the pixel position corresponding to the sensing device SD is touched or not, or the pressure of the touched pixel position to generate the corresponding change of the capacitance. Thus, the reference voltage has the corresponding change.

In one embodiment, the transforming unit 202 is a switching device. The switching device may be a semiconductor. In another embodiment, the transforming unit 202 may be any other current semiconductor device having the switching function or any semiconductor device having the switching function to be developed in the future.

In one embodiment, one terminal of the transforming unit 202 couples to a voltage source VDC or a common voltage VCOM, and the transforming unit 202 receives at least a target voltage Vt and adjusts the output current Iout passing through the transforming unit 202 according to the target voltage Vt. The value of the target voltage Vt varies with at least three variables provided by the sensing control unit 201. The three variables comprise a first variable vr1, a second variable vr2 and a third variable vr3 (to avoid the complication, vr1, vr2, and vr3, are not shown in the figures).

The first variable vr1 may be the changed quantity of the capacitance generated by the sensing device SD of the sensing circuit 20 due to being touched by a user. The second vr2 may be the enable state of a first control signal IN. The third variable vr3 may be the enable state of the second control signal CO. In one embodiment, the first control signal IN may be a scan line signal while the second control signal CO may be the former or the latter scan line signal. In another embodiment, the first control signal IN may be a scan line signal while the second control signal CO may be a signal generated by an external apparatus. In another embodiment, the first control signal IN and the second control signal CO may be both generated by an external apparatus.

It should be noted that those who are skilled in the art should understand the operation method of the embodiments of the invention from the drawings and above description. Thus, the detail of the operation will not be given herein.

In addition, it should be noted that as long as the target voltage Vt reaches a preset value, the mechanism of transforming voltage into current by the transforming unit 202 drives the switching device in the transforming unit 202 so that the corresponding current Iout is generated and passes through the switching device. For example, assuming that the default voltage value of the transforming unit 202 is 0.7V, the switching device turns on to have the current Iout pass through the switching device and be output to an external circuit (such as Integrated Circuit, IC) when the target voltage Vt is greater than 0.7V. Moreover, because the value of the Vcom or the direct current circuit VDC in the figure can be controlled at any fixed value, the current Iout output from transforming unit 202 can be fixed within a preset range. Thus, the output current Iout remains stable and is not affected by the environmental interferences. Therefore, the sensing circuit 20 can output the signal to an external circuit (such as integrated circuit, IC) to avoid any error operation and to solve the problems in the prior art.

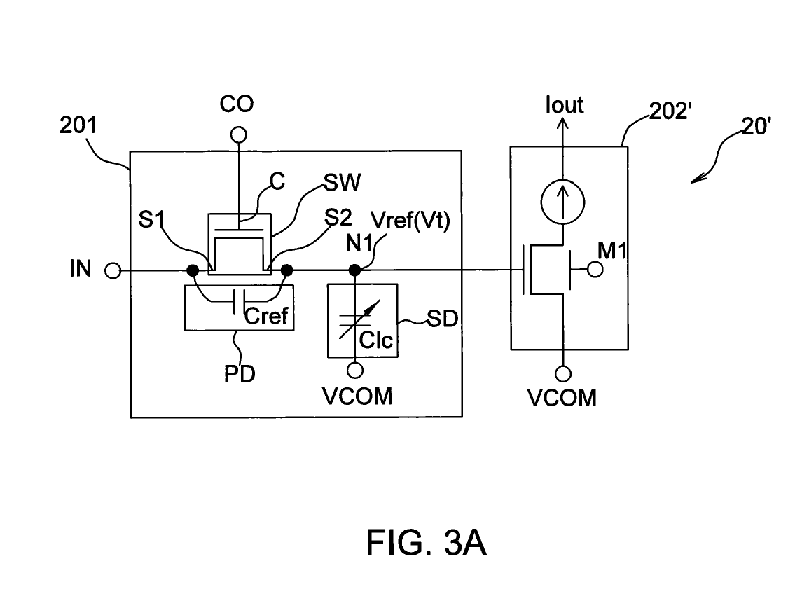

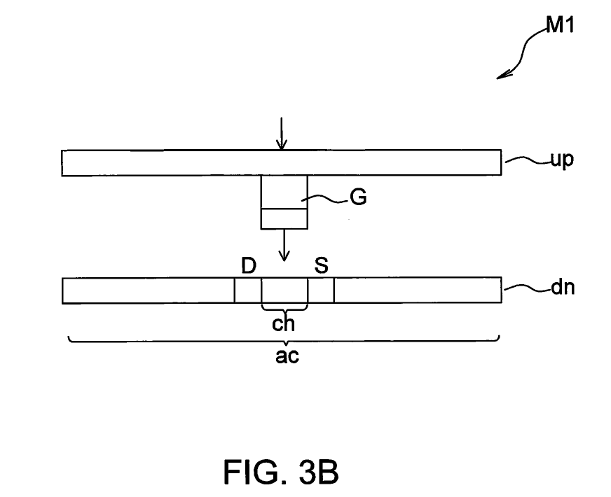

FIG. 3A shows a schematic diagram of a sensing circuit in another embodiment. The sensing circuit 20′ in this embodiment adopts a pressure-sensing type switching device M1 in the transforming unit 202′ such as the pressure-sensing type thin film transistor (MOS TFT-M1) for enhancing current sensing. The structure of the thin film transistor M1 is shown in FIG. 3B. The structure of the thin film transistor M1 comprises an upper substrate up and a bottom substrate dn. The upper substrate comprises a control electrode G while the bottom substrate comprises an active layer ac and two electrodes S and D.

The sensing circuit 20′ uses the transistor M1 and the sensing device SD be sensible synchronously while a user touches a position on the panel. For example, when a user touches a preset position of the touch panel by a finger, the distance between the upper substrate up and the bottom substrate dn on the device M1 is decreased so that the active layer ac forms a channel layer ch. Thus, pressure exerts on the panel by a user is sensed. The sensing circuit 20′ in this embodiment combines the sensing unit SD and the pressure-sensing type thin film transistor M1 to enhance its sensing function and sensing accuracy.

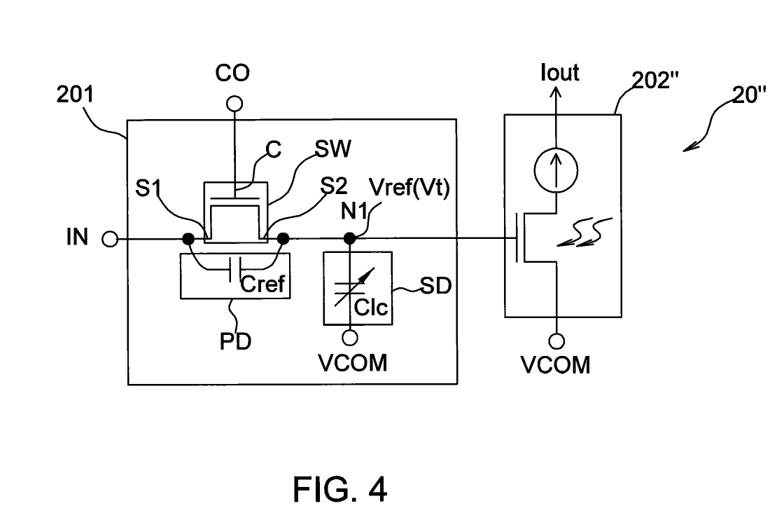

In addition, as shown in FIG. 4, in another embodiment of the invention, the transforming unit 202″ of the sensing circuit 20″ may also adopt the optical switching device with the optical sensing function, such as light sensing type photo thin film transistor (Photo TFT). When a user touches a preset position of the panel, the sensing device SD of the sensing circuit 20″ corresponding to the position senses the touched pressure, and the optical switching device also generates the change of light intensity due to touching the touch panel by a user to thereby adjust the current flowing through the optical switching device. Thus, the sensing efficiency of the sensing circuit 20″ is doubled. Therefore, combining the sensing device SD and the optical sensing function can enhance the sensing accuracy.

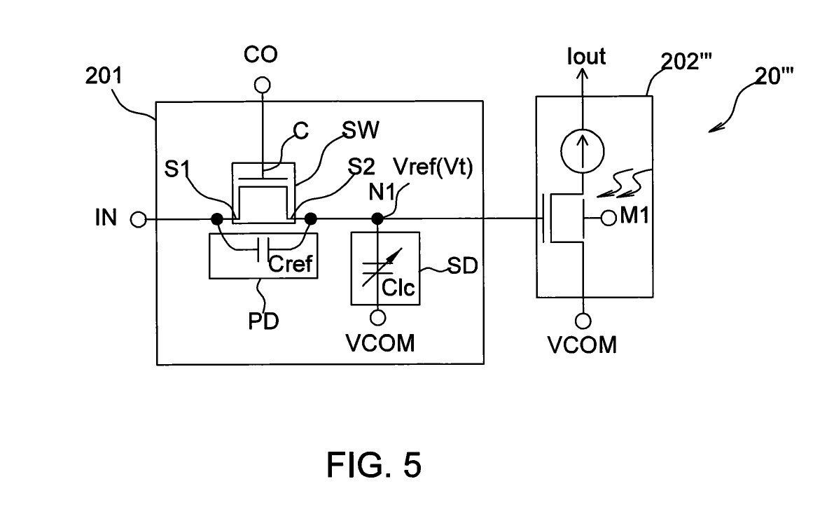

It should be noted that, as shown in FIG. 5, the transforming unit 202′″ of the sensing circuit 20′″ may combine the pressure-sensing type thin film transistor M1 and the optical thin film transistor in FIG. 3 and FIG. 4 and also operate with the sensing device SD to achieve more accurate sensing.

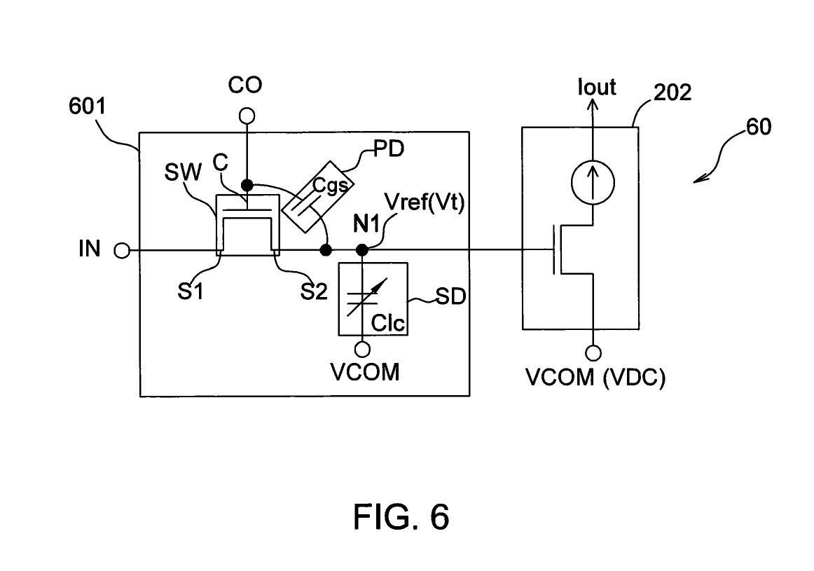

Furthermore, as shown in FIG. 6, in another embodiment of the invention, the sensing control unit 601 of the sensing circuit 60 may also utilize the Feed-through effect to achieve the effect of generating a reference voltage Vref on the node N1, by coupling a capacitor between the gate electrode (control terminal C) and the source electrode (output terminal S2) of the thin film transistor in the switching device SW. Besides, the transforming unit 202 is used to transform the reference voltage Vref into the current Iout. It should be noted that those who are skilled in the art should understand the Feed-through effect and thus the further detail is not given hereafter.

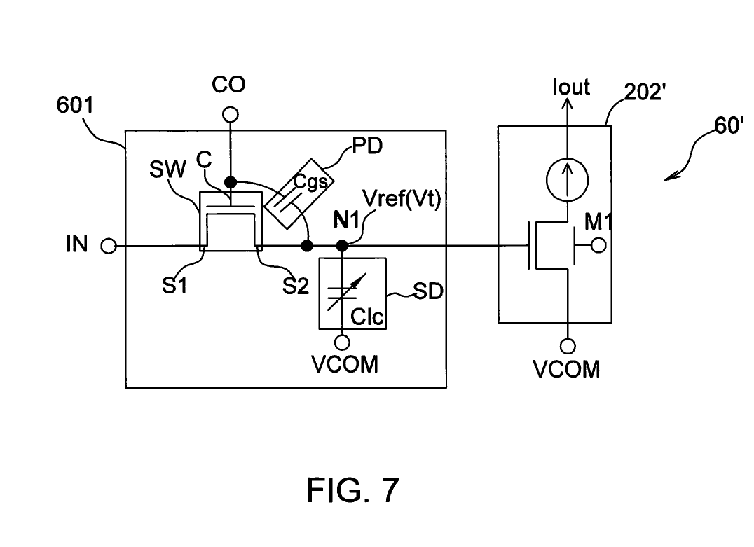

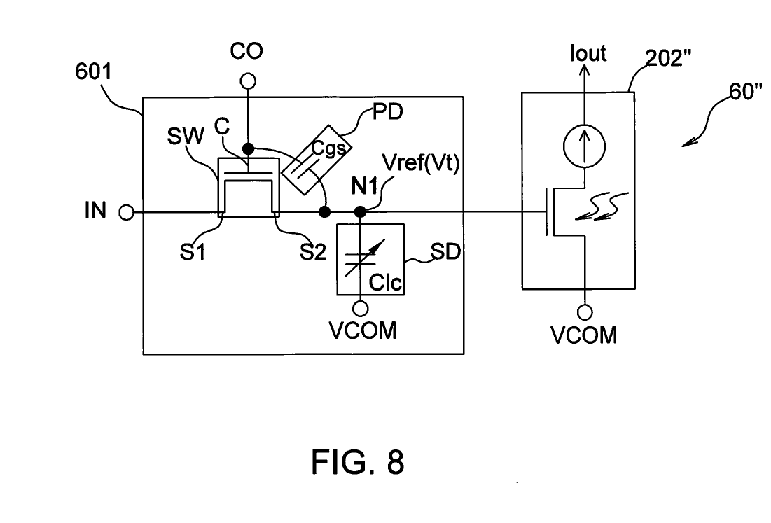

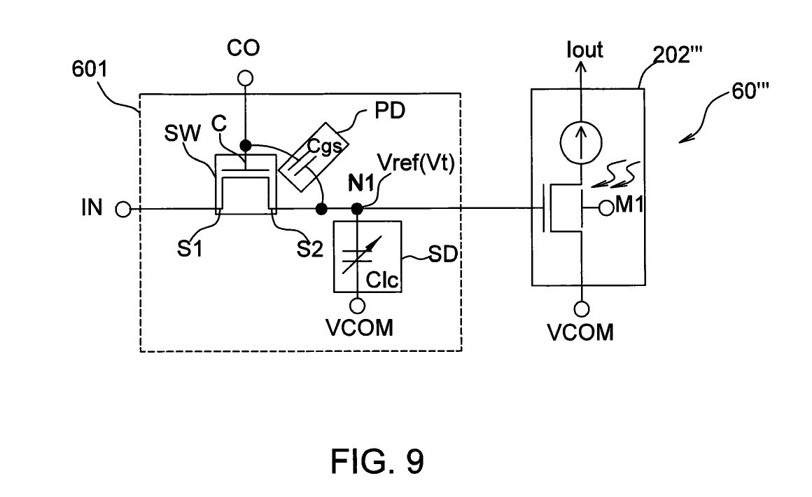

In one embodiment, as shown in FIG. 7, the sensing control unit 601 using the Feed-through effect may also adopt the transforming unit 202′ having with the pressure-sensing type thin film transistor M1 to enhance the sensing accuracy of the sensing circuit 60′. In another embodiment, as shown in FIG. 8, the sensing control unit 601 using the Feed-through effect can also adopt the transforming unit 202″ having the optical-sensing switching device to enhance the sensing accuracy of the sensing circuit 60″. In another embodiment, as shown in FIG. 9, the sensing control unit 601 using the Feed-through effect may also adopt the pressure-sensing type thin film transistor M1 and the switching device with optical sensing function to further enhance the sensing accuracy of the sensing circuit 60′″. It should be noted that those who are skilled in the art should understand the operation methods of FIG. 6˜FIG. 9 through the above description and thus the further detail is not given hereafter.

In addition, the various types of the transforming units 202 (202′, 202″, 202′″) in the above embodiments of the invention can be applied to a current touch panel or a touch panel that is to be developed in the future.

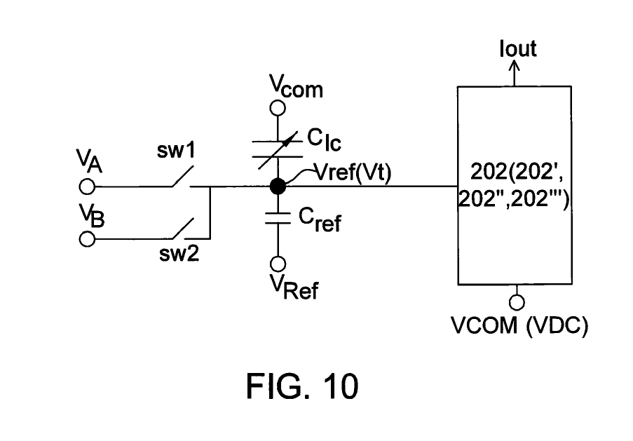

For example, as shown in FIG. 10, the schematic diagram illustrates the transforming unit 202 (202′, 202″, 202′″) operating with the capacitor type touch panel announced by Samsung in 2007. The circuit uses the capacitance of the capacitors Clc and Cref for voltage dividing and the circuit operates according to three voltages V_{A}, V_{B} and V_{Ref}. At first, the circuit is initialized by the voltage V_{A} through the switch sw1 and then the Bias voltage V_{B} is provided through the switch sw2 to the capacitor Clc and Cref for voltage dividing. During operation, the gap of the capacitor Clc changes when the user touches the capacitor Clc and the capacitance is changed accordingly so that a target voltage Vt is generated. Finally, the transforming unit 202 (202′, 202″, 202′″) of this embodiment of the invention transforms the target voltage Vt to generate the output current Iout.

The sensing circuit of the embodiments of the invention utilizes the mechanism of transforming voltage into current by the transforming unit to reduced the voltage variation caused by the environmental interferences, such as the parasitic effect of interior circuit layout in the panel so that sensing accuracy can be greatly increased. Together with the external IC, the sensing circuit can fetch different current values to determine the touched pixel. Therefore, the function of the sensing circuit is achieved, the problems of the sensing accuracy caused by the environmental interferences in the prior art are solved, and the sensing accuracy is also increased.

Although the present invention has been fully described by the above embodiments, the embodiments should not constitute the limitation of the scope of the invention. Various modification or changes can be made by those who are skilled in the art without deviating from the spirit of the invention.

What is claimed is:

1. A signal transforming circuit applicable to a sensing circuit for a touch panel, comprising:
at least a transforming unit, one terminal of which couples to a voltage source or a common voltage (Vcom), for receiving at least a target voltage and adjusting the current that flows through the transforming unit according to the target voltage;
wherein the value of the target voltage varies with at least three variables provided by the sensing circuit and the three variables comprise a first variable, a second variable and a third variable;
wherein the first variable is the variances of the capacitance generated by the sensing circuit while being touched by a user, the second variable is an enable state of a first signal which is input to the sensing circuit, and the third variable is an enable state of a second signal which is input to the sensing circuit.

2. The signal transforming circuit according to claim 1, wherein the transforming unit is one of the following or the combination thereof: pressure-sensing type switching device and optical switching device.

3. The signal transforming circuit according to claim 1, wherein the first signal is a scan line signal and the second signal is the former or the latter scan line signal.

4. The signal transforming circuit according to claim 1, wherein the first signal is a scan line signal and the second signal is the signal generated by an external apparatus.

5. The signal transforming circuit according to claim 1, wherein both of the first signal and the second signal are generated by an external apparatus.

6. A sensing circuit for a touch panel, corresponding to a pixel or a plurality of pixels of a touch panel where one pixel corresponds to a preset position on the surface of the panel, the sensing circuit for a touch panel comprises:
a sensing control unit, for generating at least a sensing signal according to the pressure exerting on a preset position of the panel touched by a user and determining a target voltage according to the sensing signal; and
a transforming unit, for receiving the target voltage and adjusting the output current of the transforming unit according to the target voltage.

7. The circuit according to claim 6, wherein the transforming unit further receives at least a control signal to determine how to drive the sensing control unit.

8. The circuit according to claim 6, wherein the transforming unit is one of the following or the combination thereof: pressure-sensing type switching device and optical switching device.

9. The circuit according to claim 6, wherein, when the sensing control unit receives two control signals, the two control signals are used to determine how to drive the sensing control unit and one or both of the two control signals are scan line signals.

10. The circuit according to claim 6, wherein, when the sensing control unit receives two control signals, the two control signals are used to determine how to drive the sensing control unit and one or both of the two control signals are generated by an external apparatus.

11. The circuit according to claim 7, wherein the control signal is selected from a scan line signal or an output signal of an external apparatus.

12. A sensing circuit for a touch panel, corresponding to a pixel or a plurality of pixels of a touch panel where one pixel corresponds to a preset position on the surface of the panel, the circuit comprising:
a switching device, for receiving a first control signal and outputting the first control signal according to a second control signal;
a passive device, coupling to the switching device;
a sensing device, coupling to the switching device to form a node, for receiving the first control signal, generating a reference voltage on the node, and adjusting the reference voltage according to the pressure exerting on a preset position of the panel touched by a user to generate a target voltage; and
a transforming unit, for receiving the target voltage and adjusting an output current passing through the transforming unit according to the target voltage.

13. The circuit according to claim 12, wherein the transforming unit is one of the following or the combination thereof: pressure-sensing type switching device and optical switching device.

14. The circuit according to claim 12, wherein the switching device comprises: at least a control terminal, at least an input terminal and at least an output terminal and one terminal of the passive device couples to the output terminal of the switching device, and the other terminal of the passive device couples to the input terminal or the control terminal of the switching device.

15. The circuit according to claim 12, wherein one or both of the first control signal and the second control signal are scan line signals.

16. The circuit according to claim 12, wherein one or both of the first control signal and the second control signal are generated by an external apparatus.

17. The circuit according to claim 12, wherein the switching device or the transforming unit is a semiconductor device or a thin film transistor, or the passive device is a capacitor or a capacitor formed by Feed-through effect.

18. A touch panel, comprising:
a plurality of pixels, corresponding to a preset position on the surface of the panel;
wherein one of the pixels or a plurality of the pixels correspond to a sensing circuit for the touch panel, that comprises:
a switching device, for controlling the on/off state of the switching device according to at least a signal;
a first capacitor, coupling to the two terminals of the switching device;
a sensing device, coupling to a terminal of the switching device to form a node, wherein a reference voltage is generated on the node when the switching device is on and the sensing device adjusts the reference voltage according to whether a user touches a preset position of the panel or the extent of touching a preset position so as to generate a target voltage; and
a transforming unit, for receiving the target voltage and outputting a corresponding output current according to the target voltage.

19. The touch panel according to claim 18, further comprising: a plurality of circuit blocks to cooperate with the operation of the pixels.

20. The touch panel according to claim 18, wherein the sensing device is variable capacitor, the first capacitor is formed by Feed-through effect, or the transforming unit is one of the following, or the combination thereof: sensing-pressure type switching device and optical switching device.
